(19) United States
(12) Patent Application Publication
(10) Pub. No.: US 2015/0074390 A1
(43) Pub. Date: Mar. 12, 2015

(54) METHOD AND DEVICE FOR CLASSIFYING RISK LEVEL IN USER AGENT BY COMBINING MULTIPLE EVALUATIONS

(71) Applicant: OPERA SOFTWARE ASA, Oslo (NO)

(72) Inventors: Terje STOBACK, Oslo (NO); Huib KLEINHOUT, Hagan (NO)

(73) Assignee: OPERA SOFTWARE ASA, Oslo (NO)

(21) Appl. No.: 14/481,577

(22) Filed: Sep. 9, 2014

Related U.S. Application Data
(60) Provisional application No. 61/876,166, filed on Sep. 10, 2013.

(51) Int. Cl. H04L 29/06

(52) U.S. Cl. CPC H04L 63/0823; H04L 63/0876
USPC 713/156

(57) ABSTRACT

The present invention is directed toward a computer implemented method and device for classifying a safety level associated with a particular network data resource (e.g., webpage) in connection with the operation of a user agent (e.g., web browser). According to the invention, the safety level is classified by performing evaluations of the data resource on each of a plurality of categories relating to security or trust, quantifying the evaluations to associate a score with each of the plurality of categories, and applying a set of rules to the obtained scores. Furthermore, based on the application of these rules, a determination can be made as to whether a precautionary measure is warranted. If so, the user is notified of the precautionary measure.

### CROSS-REFERENCE TO RELATED APPLICATION

The present application claims domestic priority under 35 U.S.C. 119(e) to U.S. Provisional Application No. 61/876,166 filed on Sep. 10, 2013, the entire contents of which are herein incorporated by reference in their entirety.

### FIELD OF THE INVENTION

The present invention relates generally to providing an indicator on a user agent (e.g., a web browser) indicating a level of security or trust for a particular website. More particularly, the present invention is directed to evaluating multiple aspects indicative of security and trustworthiness of a website, and combining these evaluations to classify an overall risk level in connection with the site.

### BACKGROUND OF THE INVENTION

Computer users typically use user agent applications to access documents or data resources that are available over a computer network to which their computer is connected. Such resources are identified by a Uniform Resource Identifier (URI), usually a Uniform Resource Locator (URL), which identifies the resource uniquely and provides the information necessary for locating and accessing the resource. A web browser is a type of user agent commonly used to navigate the World Wide Web (i.e., the system of interlinked hypertext documents accessible on the Internet), in order to access a particular information resource (or “webpage”) and present it to the user.

However, many information resources are made available on the World Wide Web with malicious intent. As one example, “phishing” refers to a technique whereby a webpage masquerades as a popular and trustworthy website such as a bank site, an auction site, or a retail shopping website. Some phishing sites intend on tricking a computer user to provide confidential information (e.g., password, account number, social security number, etc.). Other phishing sites try to cause the user to download “malware,” i.e., malicious software which is intended to disrupt operation of the user's computer or gather sensitive information therefrom. Examples of malware include computer viruses, worms, spyware, and Trojan horses.

Existing user agents such as web browsers are capable of notifying a computer user of certain attributes of a data resource or website which are indicative of a level of security and a possibility of risk. For instance, it is known for a browser to display a padlock icon in the address field for websites that utilize encryption, according to the Hypertext Transfer Protocol Secure (HTTPS) scheme, for site authentication and bidirectional encryption. Also, existing browsers are able to display an alert when the user attempts to navigate to a known phishing or malware site.

While existing browsers are capable of evaluating different characteristics of a website relating to security or risk, such browsers present these evaluations as separate pieces of information, without any attempt to combine them into a single assessment of the risk level associated with the website.

### SUMMARY OF THE INVENTION

The present invention is directed toward a computer implemented method and a device for evaluating and quantifying several aspects of security and risk associated with accessing a network data resource (e.g., webpage), and combining these quantifications to classify an overall safety level of the data resource. Particularly, a user agent (e.g., web browser) may be programmed to display this safety level to the user when an attempt is made to visit or access the data resource. In further embodiments of the invention, the user agent may also implement a precautionary measure if deemed appropriate based on the level of risk. Such precautionary measure may be selected from displaying a warning to the user and blocking access to the data resource. In addition, the user agent may display the individual quantifications to the user in combination with the overall level of risk.

### BRIEF DESCRIPTION OF THE DRAWINGS

FIG. 1 is a computing device that can be used to implement an exemplary embodiment of the present invention;

FIG. 2 is a user agent for accessing data resources in accordance with an exemplary embodiment of the present invention;

FIG. 3A is a flowchart illustrating a process whereby a user agent (e.g., web browser) may classify a safety level of a particular data resource (e.g., website) in accordance with an exemplary embodiment of the present invention;

FIG. 3B is a flowchart illustrating a process whereby a user agent (e.g., web browser) may continuously classify the safety level of a particular data resource (e.g., website) in accordance with an alternative exemplary embodiment of the present invention;

FIG. 4 is a flowchart illustrating a process whereby categories relating to security or trust are evaluated for a particular data resource (e.g., website) in accordance with an exemplary embodiment of the present invention;

FIGS. 5-15 are screen shots illustrating how the classified safety level and other pertinent information regarding the evaluations may be displayed to a user of the user agent, in accordance with exemplary embodiments of the present invention; and

FIGS. 16-18 are screen shots illustrating detailed explanations which may be displayed in regard to certain categories, in accordance with exemplary embodiments of the present invention.

### DETAILED DESCRIPTION

The present invention is directed toward a computer implemented method and a device for classifying the safety level, or level of risk, involved with accessing a particular data resource on a network. The method may typically be implemented as part of a user agent, e.g., a web browser, to analyze the safety (risk) level associated with a data resource (e.g., webpage or website).

Specific embodiments are described hereinafter in which the user agent is a web browser for accessing particular data resources, such as webpages or documents, over the Internet using the HTTP (Hypertext Transfer Protocol). However, the principles described hereinafter could more broadly be applied to other types of user agents, data resources, and networks. Therefore, when the terms “browser,” “web browser,” and the like is used hereinafter to describe various aspects or principles of the present invention, it should be recognized that such aspects or principles are also applicable to other types of user agents. Likewise, when terms such as “webpage,” “document,” “website,” and the like are used hereinafter to describe certain aspects or principles of the invention, the same aspects or principles are also applicable to other types of data resources.

According to an exemplary embodiment, the user agent or browser is programmed to provide each active browsing context (e.g., tab or window) with its own “security advisor,” i.e., the capability of classifying the safety level of the webpage to which the tab/window has been directed. This security advisor may further consist of numerous “observers,” each having the task of monitoring, discovering, and/or relaying a specific type of information of interest. This is used to update a transitory knowledge base of the active page. Further, the security advisor contains multiple quantifiers each of which is programmed to analyze and evaluate a particular aspect of security or trust in regard to the webpage or site, based on the current body of knowledge as maintained in the transitory knowledge base. Through the use of these quantifiers, multiple categories relating to security or trustworthiness may be evaluated. These categories may include, e.g., Encryption, Certificate, Familiarity, Reputation, and Inquisitiveness of the site. There may be a quantifier for each of these categories. Further, as the name implies, each of the quantifiers may quantify its evaluation, in order to produce a score for the corresponding category.

In addition to the observers, transitory knowledge base, and quantifiers, the security advisor may include a “risk assessor.” This risk assessor receives the scores from the quantifiers and combines them into a single classification of the safety level. According to a particular exemplary embodiment, this risk assessor may be programmed to apply a set of rules to the scores, in order to classify the safety level associated with the webpage or site. Also, in addition to classifying the safety level, the risk assessor may also determine whether a precautionary measure needs to be taken based on the application of the rules. For instance, if the safety level is classified as SUSPICIOUS or UNSAFE, the risk assessor may decide that it is necessary either to display a warning to the user or block access to the webpage or site.

According to a further exemplary embodiment, one or more of the observers in the security advisor may continuously react to events (e.g., the arrival of network data, changes in the webpage structure, or even a regular timer) by updating the transitory knowledge base, even after a webpage or site has been classified as safe. Further, whenever the body of knowledge of the active webpage (as stored in the transitory knowledge base) changes, this may trigger a new evaluation by one or more of the quantifiers, and also a new classification of the safety level by the risk assessor. This allows for a real-time analysis of the safety level of the webpage or site so that, whenever an observer makes a discovery that might affect the safety level, this information would trigger a new analysis of the risk involved with the webpage.

The aforementioned components including the security advisor, observers, and risk assessor may be coded as any combination of rules, functions, routines, and/or sub-routines programmed into a user agent, or alternatively may be coded separately from the user agent, e.g., as an “add-on.”

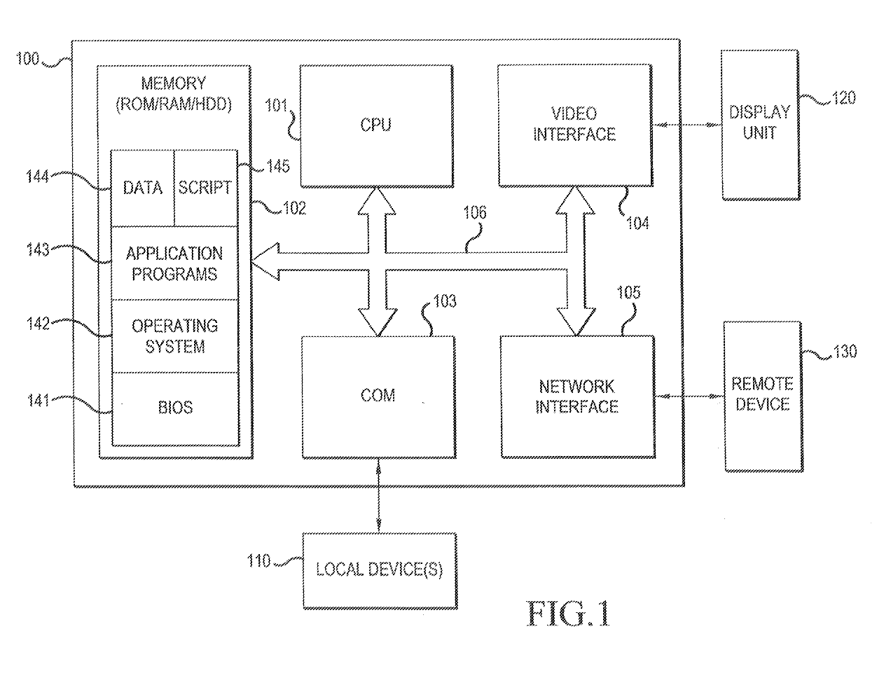

FIG. 1 illustrates a generalized computing device 100 that can be used as an environment for implementing various aspects of the present invention. In FIG. 1, a device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memory, stores the various software components of the system. The software components in the memory 102 may include a basic input/output system (BIOS) 141, an operating system 142, various computer programs 143 including applications and device drivers, various types of data 144, and other executable files or instructions such as macros and scripts 145. For instance, the computer programs 143 stored within the memory 102 may include any number of applications, including the user agent and other program(s) used for implementing the principles of the present invention, as well as any other programs (e.g., widgets) designed to be executed in a user agent environment.

In FIG. 1, the communication ports 103 may be connected to one or more local devices 110 such as user input devices, a printer, a media player, external memory devices, and special purpose devices such as e.g. a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the device 100 with the ability to connect to a network in order to communicate with a remote device 130. The communication network, which in FIG. 1 is only illustrated as the line connecting the network interface 105 with the remote device 130, may be, e.g., a local area network or the Internet. The remote device 130 may in principle be any computing device with similar communications capabilities as the device 100, but may typically be a server or some other unit providing a networked service.

It will be understood that the device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present. Furthermore, the device 100 may, e.g., be a general purpose computer such as a PC, or a personal digital assistant (PDA), or even a cellphone or a smartphone.

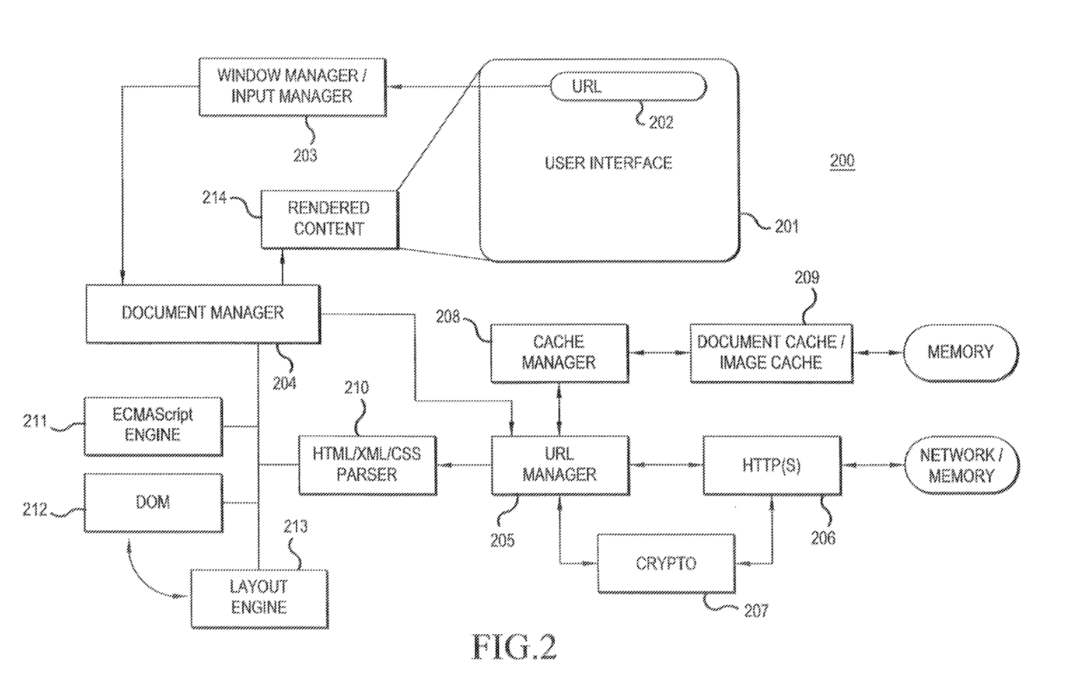

In an exemplary embodiment, various aspects of the present invention may be incorporated into, or used in connection with, the components and/or functionality making up a user agent or browser installed as an application on a device 100. FIG. 2 shows an example of a number of modules that may be present in such a user agent or browser. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The user agent or browser 200 presents the user with a user interface 201 that may be displayed on the display unit 120 shown in FIG. 1. The user interface 201 may include an address field 202 where the user may input or select the uniform resource locator (URL) of a webpage or document he or she wants the user agent 200 to retrieve. For example, the user may use an input device (e.g., keyboard) to type in the URL in the address field 202. The address field 202 may also be a link that is displayed and may be activated by the user using a pointing device such as a mouse. Alternatively, the URL may be specified in the code of a document or script already loaded by the user agent 200.

In any case, the URL may be received by a window and input manager 203 that represents the input part of the user interface 201 associated with, or part of, the user agent 200. The URL may then be forwarded to a document manager 204, which manages the data received as part of the document identified by the URL.

The document manager 204 forwards the URL to a URL manager 205, which instructs a communication module 206 to request access to the identified resource. The communication module 206 may be capable of accessing and retrieving data from a remote device 130 such as a server over a network using the hypertext transfer protocol (HTTP), or some other protocol such as HTTP Secure (HTTPS) or file transfer protocol (FTP). The communication module 206 may also be capable of accessing data that is stored in local memory 102.

If communication outside the device 100 is required to be encrypted, e.g. as specified by the protocol used to access the URL, encryption/decryption module 207 handles communication between the URL manager 205 and the communication module 206.

The data received by the communication unit 206 in response to a request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the user agent 200 described above may be implemented as an application program 143, some of the user agent's 200 functionality may also be implemented as part of the operating system 142 or even the BIOS 141 of the device 100. The content received in response to a URL request may be data 144, script 145, or a combination thereof as further described below.

Principles of the present invention will be described below in connection with the particular example of a web browser 200 as illustrated in FIG. 2. However, such description is not intended to limit the invention to such a web browser 200, and the principles described hereinafter will equally apply to other types of user agents 200 as will be contemplated by persons of ordinary skill in the art.

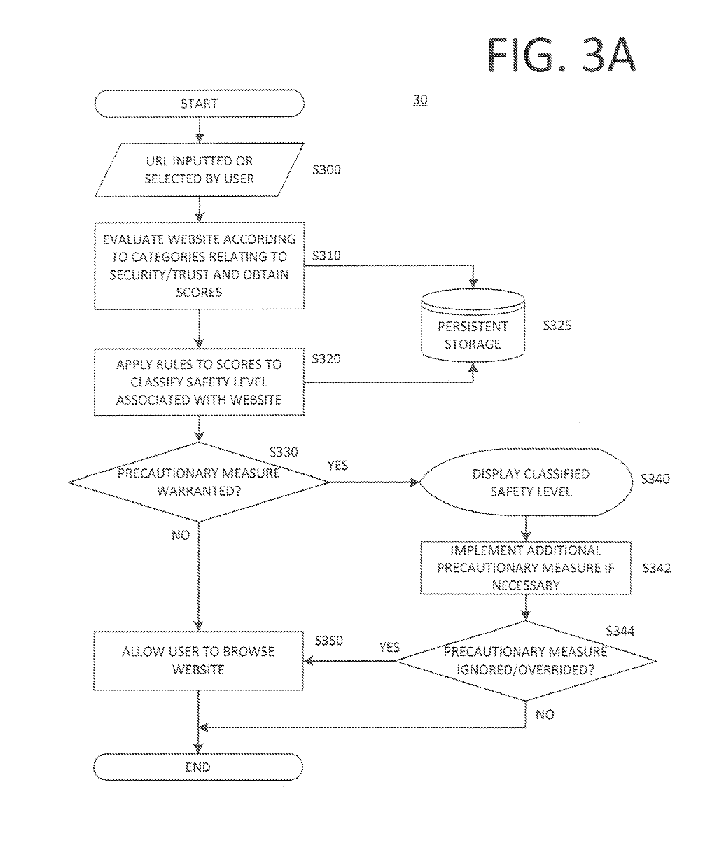

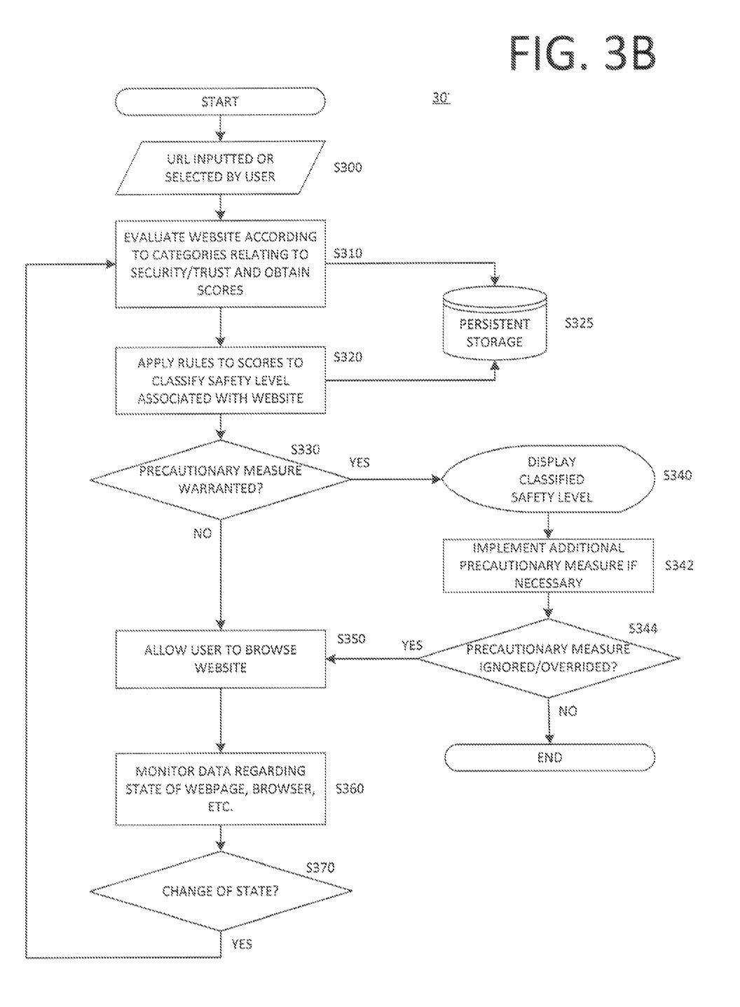

Reference is now made to FIG. 3A which is a flowchart illustration of a process 30 to be executed in conjunction with the browsing activities of a web browser 200, to classify a level of safety or risk associated with a browsed document or website. Please note that this figure is merely illustrative of one possible example for implementing the principles of the invention. For instance, the sequence of the operations may be rearranged, certain operations may be omitted, and others may be combined without departing from the spirit and scope of the invention.

The term “security advisor” is used herein to describe each implementation of the process 30 illustrated in FIG. 3A and described hereinafter. As described earlier, it is contemplated that a security advisor can be implemented for each browsing context of a browser 200. E.g., if multiple tabs or windows in the browser 200 have been opened to concurrently access multiple documents, each tab or window may have its own security advisor running in order to classify the safety/risk of the corresponding document.

Referring to FIG. 3A, according to operation S300, a URL is designated to the browser 200. According to an exemplary embodiment, the user may input the desired URL by typing it into the address field 202, clicking on a link in another document, selecting a bookmark maintained by the browser 200, etc. However, it is not necessary for the URL, which is obtained in operation S300, to be selected by the user. Instead, in S300, the user agent 200 may be directed to the URL automatically, e.g., it could be the set as a browser's homepage, or else the browser 200 may be automatically redirected there by means of a script that is executed.

After the relevant URL is obtained, the corresponding webpage or website is evaluated according to operation S310. Particularly, according to S310, various pieces of data which might be relevant to the security or risk involved with the active website or page may be collected by functional units which are called “observers” in this specification, and then multiple categories relating to security or risk are evaluated according to the collected data. The term “quantifier” is used in this specification to describe the functionality whereby each one of these categories is evaluated. As such, multiple observers and quantifiers may be employed by the security advisor to perform the evaluations of S310.

The types of data which may be collected by the observers in S310 may include e.g., document content or patterns therein, details of security protocols (e.g., Secure Sockets Layer (SSL)) utilized by the site, details on security policy declared by the site (e.g., HSTS), results of site authentication, characteristics of the web server hosting the site, whether the site attempts to collect geolocation data from the browser 200, details of the site's certificate chain, the site's reputation among third parties, and/or whether any of the site's software matches a malware registry. Other types of information collected by observers may include user input actions while browsing the site, the user's browsing history information, and details regarding the browser's network or Wi-Fi connection.

The set of categories which are evaluated by quantifiers in S310 may include, e.g., encryption employed by the site, nosiness or inquisitiveness of the site, familiarity with the site, reputation, quality and validity of the site's certificate chain, content of the webpage, or any subset thereof. Other categories which are not listed herein may also be evaluated by a quantifier. Further, in performing its evaluation, each quantifier may be configured to perform one or more of the following analyses: look for a particular pattern in the content or structure of the document residing at the website, examine details of a certificate employed by the site, asking a third-party's opinion of the site, analyze a history of past evaluations and/or risk classifications of the site, compare a “fingerprint” of the site with a previous visit, etc.

The score produced by each quantifier may be a numeric quantification, but this is not strictly necessary. It is contemplated that a quantifier could produce another type of score which expresses a degree to which a certain characteristic or quality is exhibited by the webpage or site. This could be done by choosing from a finite set of choices, which is representative of a range or scale. An example of this is a quantifier which produces a score by choosing one of HIGH, MEDIUM, and LOW. Another example is a quantifier which chooses one of POOR, AVERAGE, and EXCELLENT. It is not strictly necessary for this set of choices to be representative of a range or scale, as long as the score is obtained by selecting from a predetermined set of choices. E.g., the score may be produced simply by classifying something according to a limited number of classifications (as long as such classifications are understood by the “risk assessor” described below).

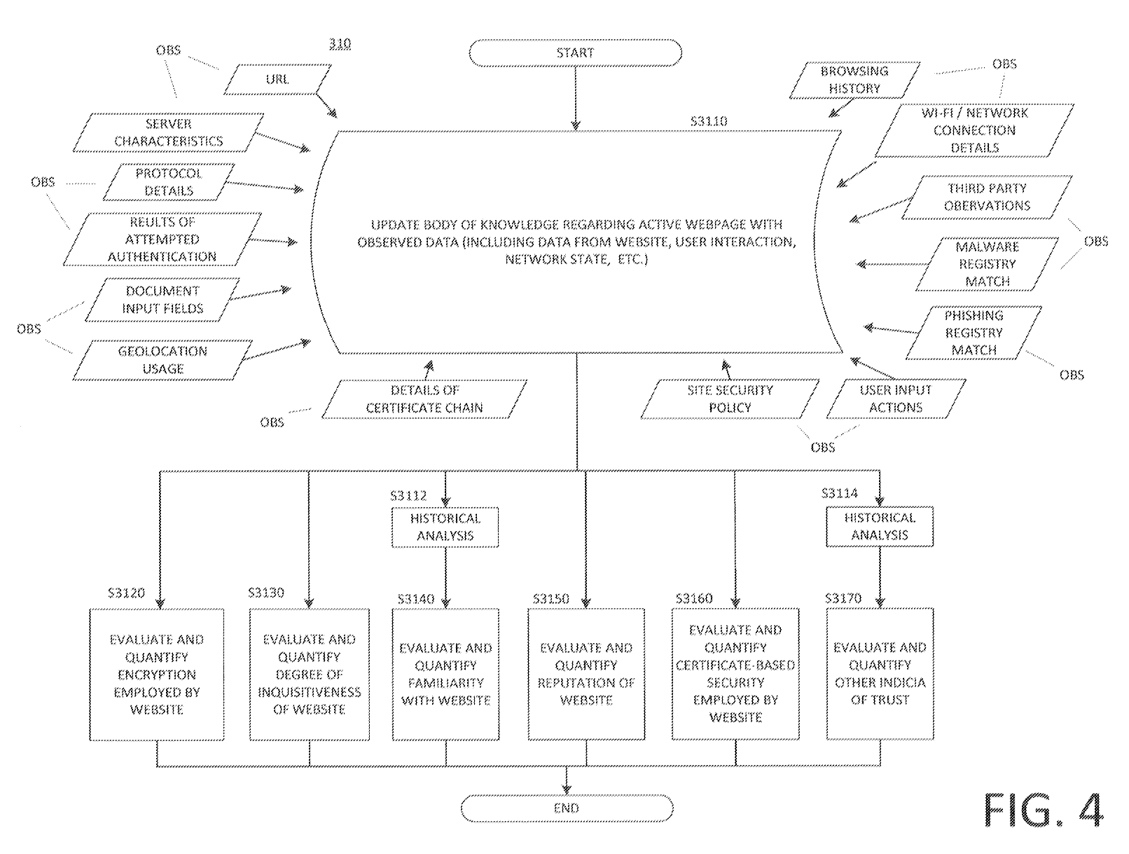

For a more detailed discussion of the observers, the quantifiers, and the categories which are evaluated in operation S310, will be provided below in connection with FIG. 4.

Referring again to FIG. 3A, according to operation S320, a set of classification rules are applied to the category scores produced by the quantifiers, in order to classify a safety level to the webpage or site associated with the URL. For purposes of this specification, the functionality of the security advisor for applying these rules and classifying the safety level is referred to as a “risk assessor.” For instance, the rules may include a set of “If-Then” conditional statements programmed into the risk assessor. However, the rules may also be implemented in tabular form. The format of these rules is a not important, and is a matter of design choice.

Particular examples of such rules (formatted as If-Then statements) are provided in Table 1 below. In these examples, it is assumed that observers are provided for the respective categories of “Certificate Quality,” “Reputation,” and “Degree of Inquisitiveness”; and that each of these categories are scored on a scale of 0 to 10.

TABLE 1

| | |
|---|---|
| 1. | If the “Certificate Quality” score ≦ 2, the “Reputation” score < |
| | 5, and the “Degree of Inquisitiveness” score > 5, then the |
| | Safety Level is classified as RISKY. |
| 2. | If the “Certificate Quality” score > 8, the “Reputation” score > |
| | 5, the “Encryption” score > 8, and the certificate class is |
| | Extended Validation (EV), then the Safety Level is classified as |
| | SAFE. |

However, as mentioned earlier, it is not strictly necessary for the scores to be numeric. Instead, they can be other types of scores indicative of a scale or a range. For example, the scores could be chosen from the following set: TERRIBLE, POOR, AVERAGE, GOOD, and EXCELLENT. If this the case, the same rules as above could be described differently, as indicated in Table 2 below:

TABLE 2

| | |
|---|---|
| 1. | If the “Certificate Quality” score is TERRIBLE, the |
| | “Reputation” score is POOR, and the “Degree of |
| | Inquisitiveness” score is MEDIUM, then the Safety Level is |
| | classified as RISKY. |
| 2. | If the “Certificate Quality” score is EXCELLENT, the |
| | “Reputation” score is GOOD, the “Encryption” score is |
| | EXCELLENT, and the certificate class is Extended Validation |
| | (EV), then the Safety Level is classified as SAFE. |

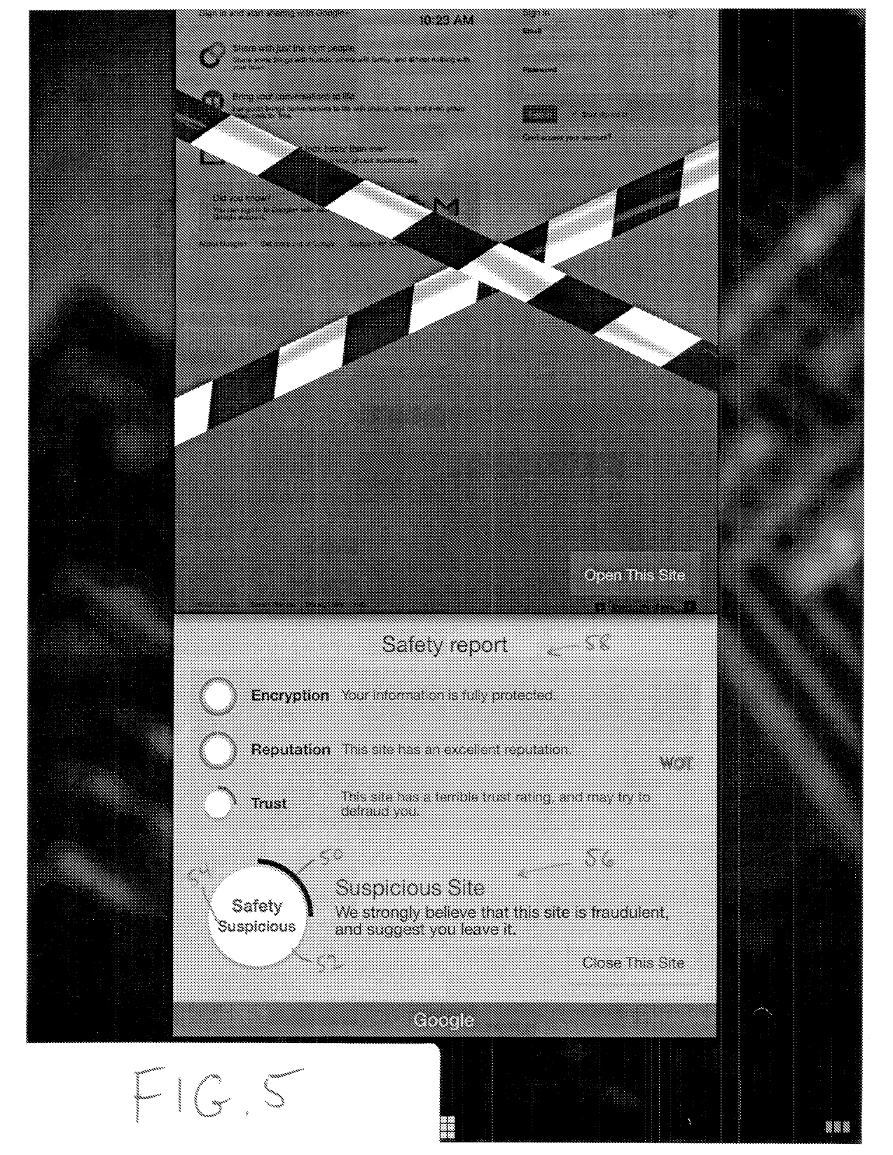

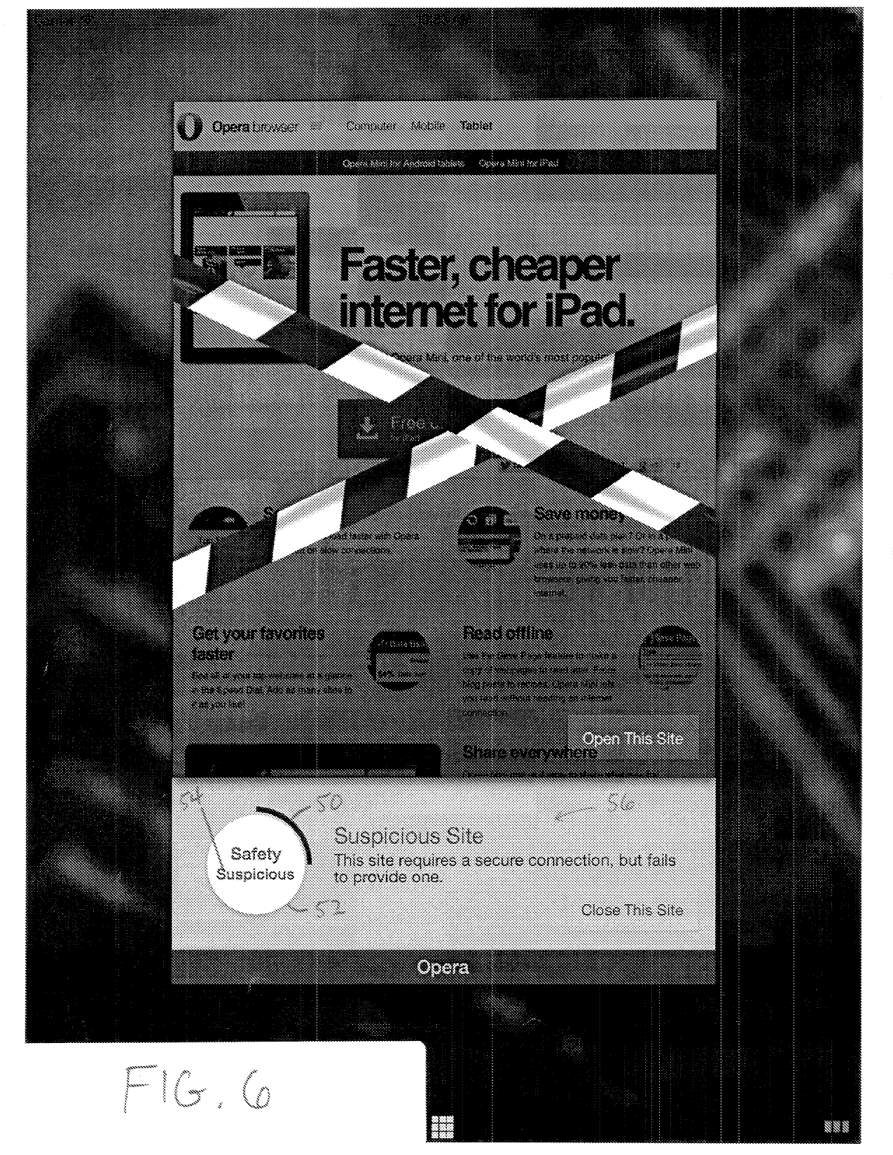

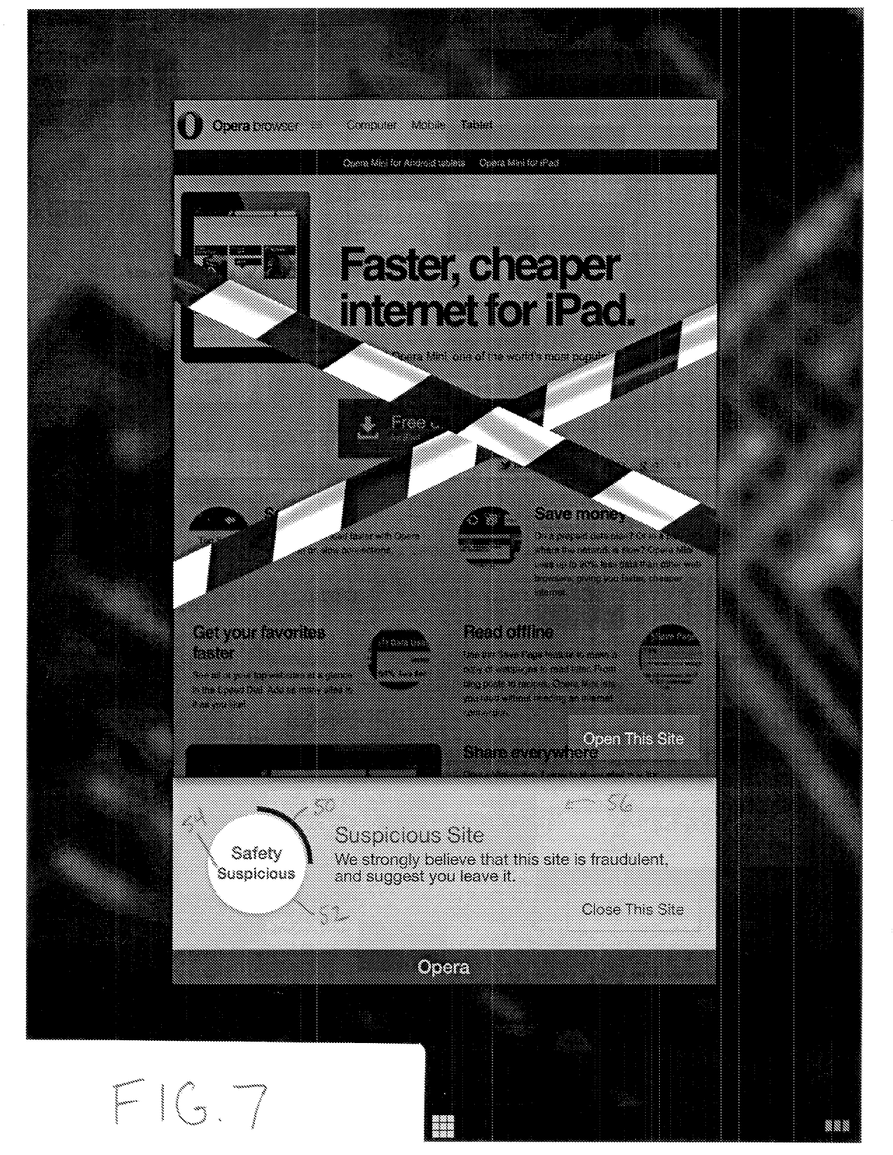

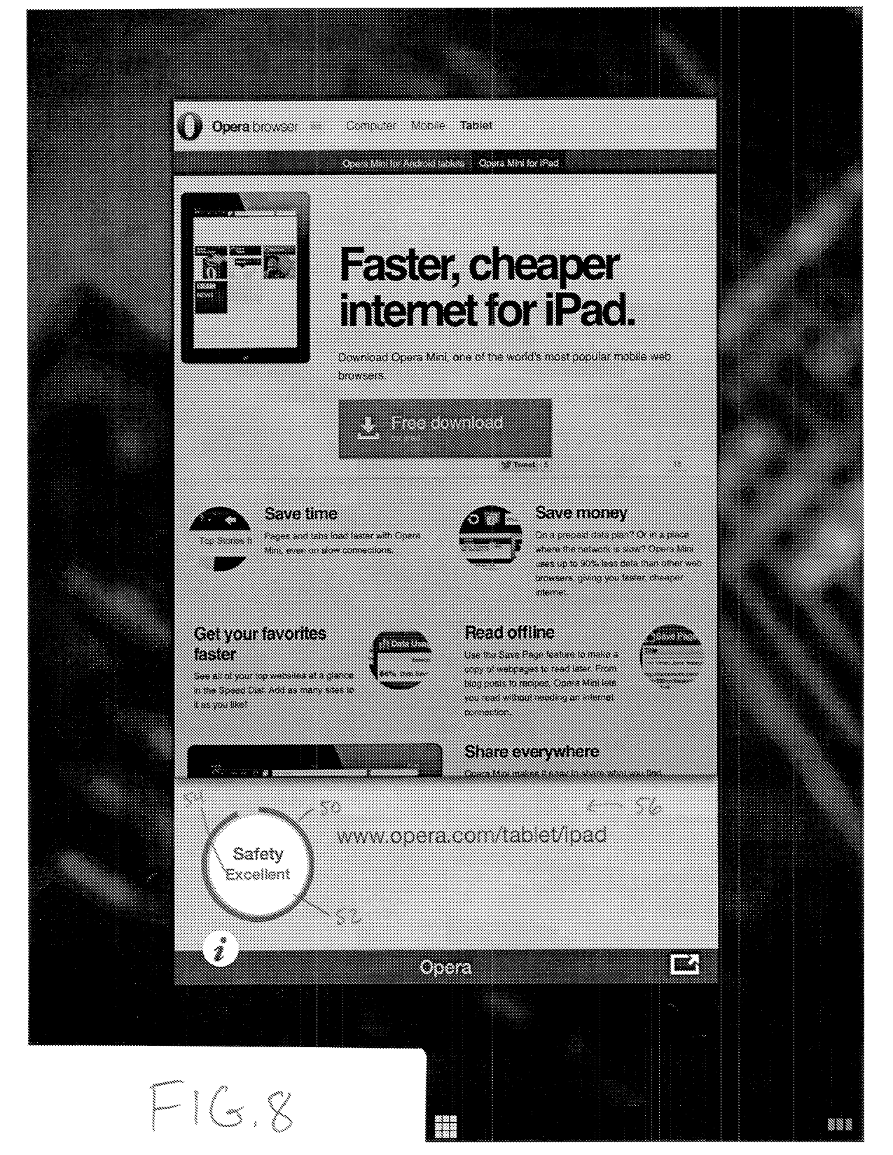

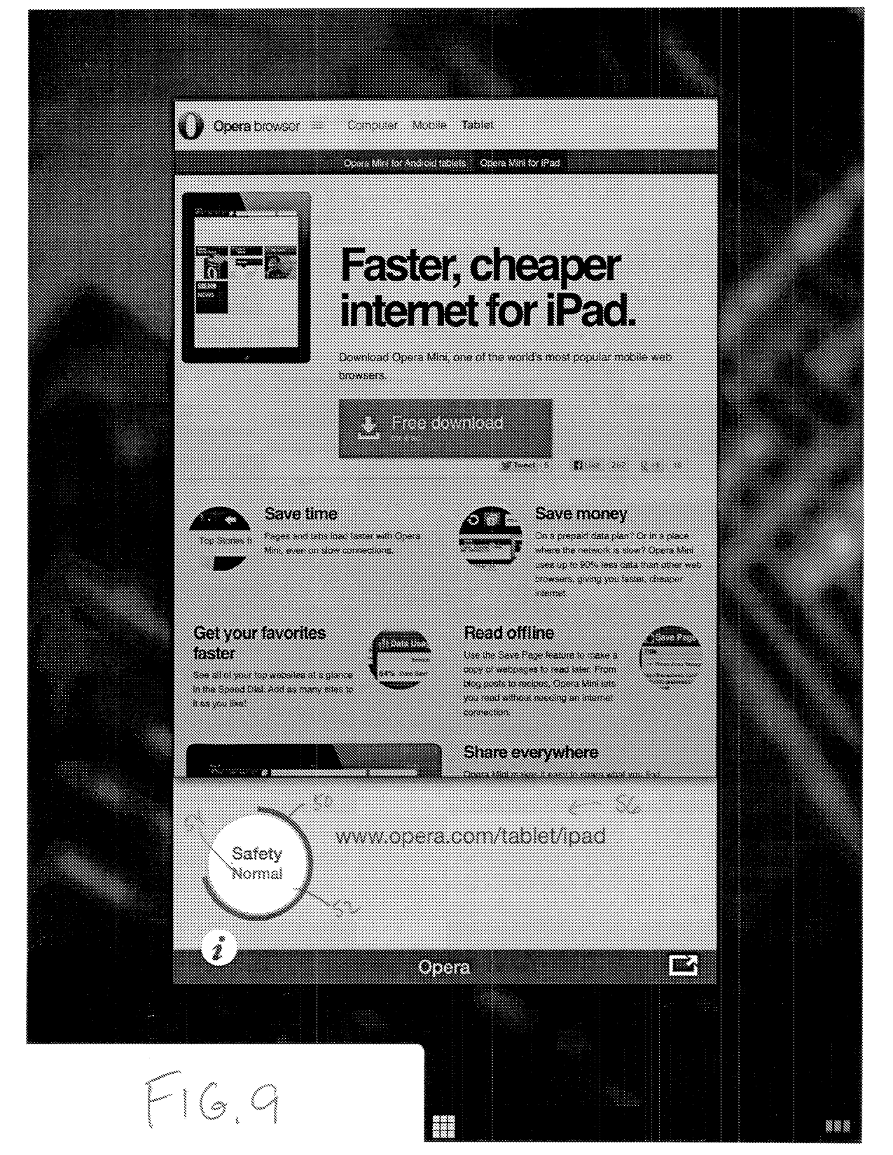

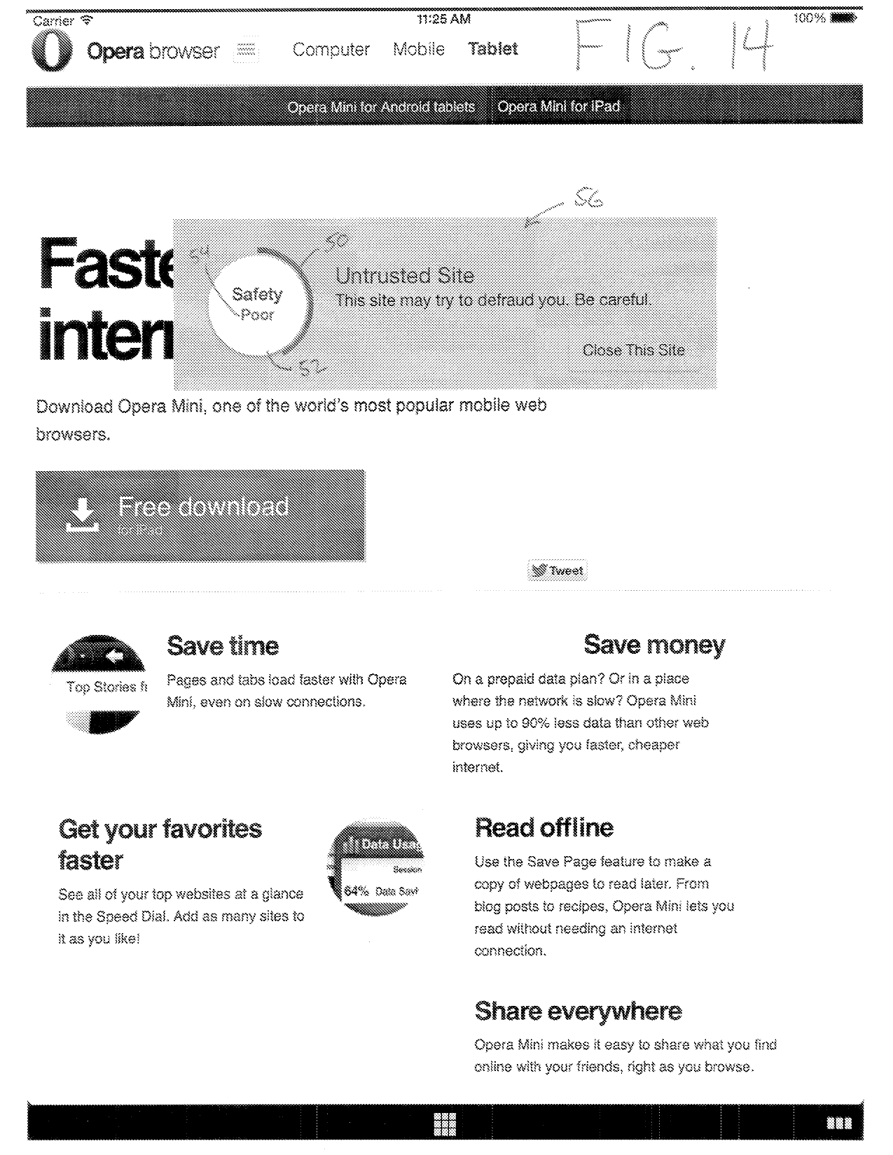

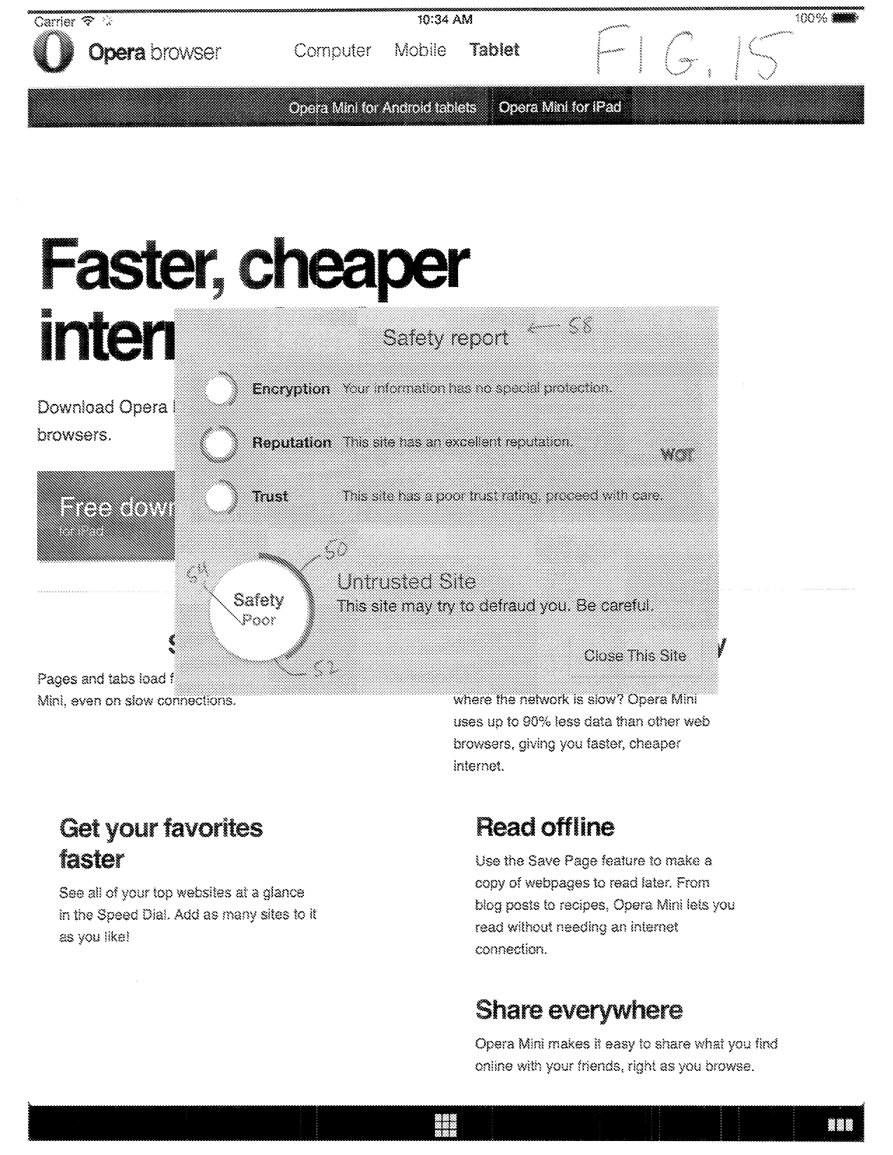

According to an exemplary embodiment, the rules applied in operation S320 could classify the safety level according to a set of classifications, each indicative of a degree of risk involved in accessing the webpage or site. For instance, in the above tables, the rules are based on an embodiment in which the safety level is classified as UNSAFE, RISKY, or SAFE. Another example of a set of classifications indicative of risk is SUSPICIOUS, POOR, NORMAL, and EXCELLENT. Examples of this second set of classifications are illustrated in FIGS. 5-15.

As such, it should be noted that Tables 1 and 2 merely provide examples in regard to the types of scores and the classifications of safety level. In fact, it is contemplated that there could be many more (and more complex) rules. As such, Tables 1 and 2 above should not be construed as being limiting on the types of rules, scores, and safety level classifications. For instance, the scores may be generated from any range (e.g., a scale of 1 to 100), and there may be more (or possibly less) classifications of safety level. Also, while the rule examples above directly classify the safety level into classifications such as UNSAFE, RISKY, and SAFE, this may not be the case. For instance, it would be possible to configure the rules to quantify the safety level, e.g., as a number between 1 and 100. It would also be possible to provide an additional rule to define numeric ranges for classifications such as UNSAFE, RISKY, and SAFE, and then determine in which of these ranges the numeric value of the safety level fits.

Referring again to FIG. 3A, after the evaluations are performed in S310 and the rules are applied in S320, the results of these analyses (including the classified safety level, the scores, any other relevant information obtained during these analyses, or any combination thereof) may be stored in a memory or storage device (i.e., a persistent storage) according to operation S325. For instance, as indicated earlier, two of the categories which are evaluated in S320 may correspond to “Familiarity” and “Trust.” Evaluating a site for Familiarity may include analyzing not only how many times a website has been visited before, but also whether the site looks the same (or similar) as before, and carries the same “fingerprint” as during a previous visit. The evaluation for Trust may include determining whether there has been a sudden regression or drop-off in the classified safety level. The historical information of previous evaluations and safety level classifications, as stored in S325, would be helpful in performing such analyses. This historical data could be stored in a designated portion of the memory 102 of the computing device 100. It is also noted that the cache 209 of the browser 200 may be used to provide historical data of a website that is useful, e.g., in determining whether the website looks similar as before.

Referring again to FIG. 3A, in operation S330, a determination is made as to whether a precautionary measure is warranted. This determination may be made based on application of the rules in operation S320, e.g., if the classified safety level is indicative of a high enough degree of risk. If S330 decides that a precautionary measure is warranted, then the browser 200 proceeds to display the classified safety level 54 to the user according to operation S340. According to S340, the classified safety level 54 may be displayed in an “indicator” 56, e.g., a dialog box (or at least a portion thereof). Further, if a numeric value has been calculated for the safety level, both the numeric value and the classification 54 could be simultaneously displayed to the user of the browser 200 according to S340. Moreover, it would not be necessary to display the actual numeric value, but to indicate the numeric value in other ways. For instance, FIGS. 5-14 illustrate examples where the browser 200 provides an indication 50 of the numeric value as a bar which extends along the perimeter of a circle 52 for a distance commensurate with the numeric value. As illustrated in these figures, the classified safety level 54 (SUSPICIOUS, POOR, NORMAL, or EXCELLENT) may also be displayed in this circle.

Furthermore, it may be decided that, in addition to displaying the classified safety level, another precautionary measure may be needed. Other precautionary measures may include (but are not limited to) displaying a more detailed warning or explanation to a user, and blocking access to the relevant webpage or website. If either (or both) of these additional precautionary measures are deemed warranted, they could be activated according to operation S342. It is possible for multiple precautionary measures to be activated in S342. For instance, if access to the website is blocked, it might also be useful to display a warning explaining why the site has been blocked.

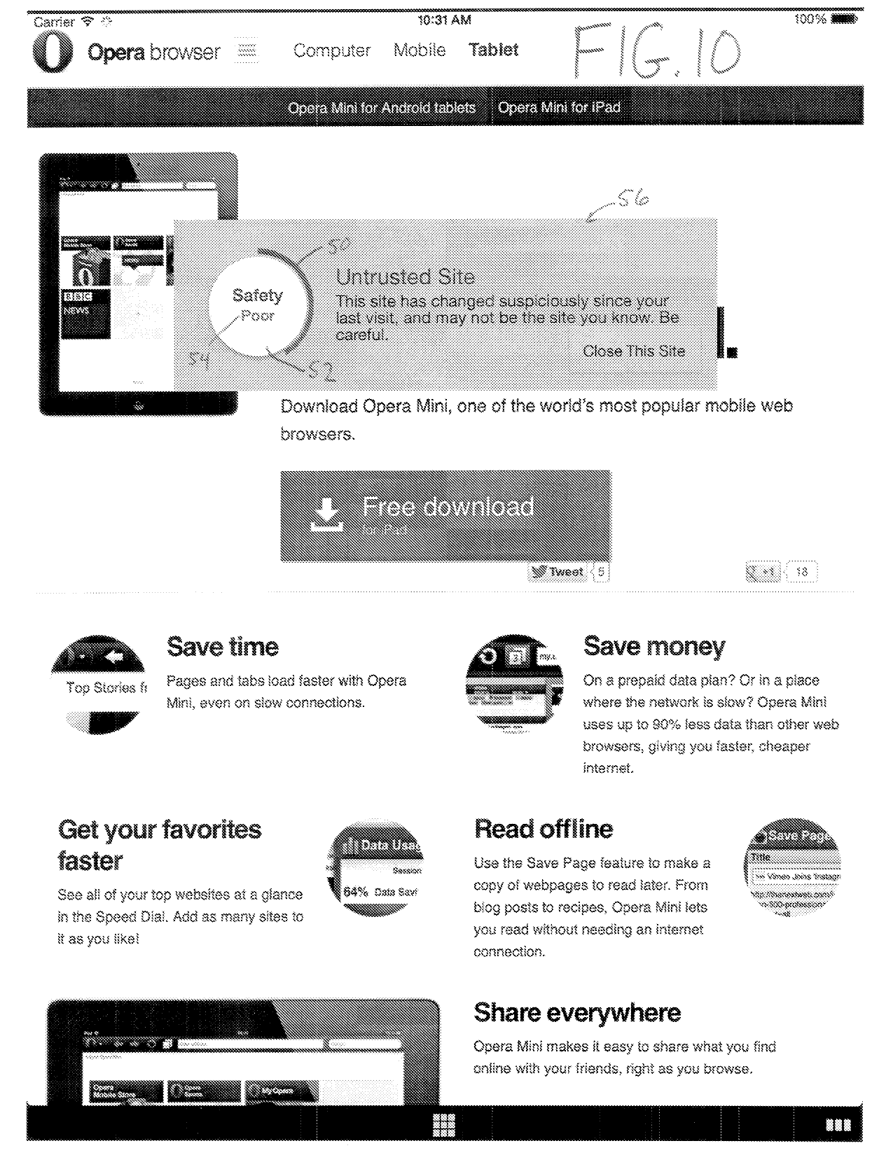

Furthermore, the user may be given an option of overriding any precautionary measures implemented, so that he/she can proceed to browse the site. This is illustrated in FIG. 3A as operation S344. If only a warning is displayed, the dialog box or indicator 56 may further provide a “Close This Site” button to allow the user to opt out of browsing the site (examples of which are shown in FIGS. 10-15). Thus, the user can override the warning by simply not clicking this button, but instead clicking somewhere else on the webpage. If, however, access to the website is blocked (examples of which are shown in FIGS. 5-7), the user may need to click on an “Open This Site” button in order to override the blocking of the site, and continue browsing.

For instance, consider the example where the safety level is classified as one of SUSPICIOUS, POOR, NORMAL, and EXCELLENT. The security advisor may determine that the precautionary measure of displaying a warning is necessary, if the safety level is classified as POOR. On the other hand, if the safety level is classified at SUSPICIOUS (which is indicative of the highest degree of risk), then the security advisor may determine that it is necessary to block the site. As such, the classified safety level, as determined by application of the rules in S320, may ultimately be determinative of whether, and what type of, precautionary measure is needed.

Furthermore, it is also possible for the rules in S320 to determine the content of the warning which might be displayed. For instance, at least some of these rules may be configured to determine a particular subcategory of risk which is relevant to the webpage or cite. Such subcategory may be determined only when the classified safety level is indicative of a threshold level of risk (e.g., POOR) or higher.

For instance, each of the aforementioned subcategories may be indicative of a specific type of risk that is associated with webpage. Examples of these specific types of risk may include:
A potential “man-in-the-middle attack” (MITM). An MITM refers to a technique whereby an attacker makes independent connections with both the browser 200 and the purported website, and makes both sides believe that they are talking directly to each other.
Potential “phishing.” Particularly, phishing is a technique whereby a webpage attempts to fool a computer user to provide confidential information (e.g., password, account number, social security number, etc.). As an example, a phishing site may masquerade as a popular and trustworthy website (such as a bank site, an auction site, or a retail shopping website).
Other types of potential fraud. E.g., even if a website has good encryption and a solid certificate, other users of the site may have been defrauded by the owner of the site. Thus, a site with poor reputation among third parties might be a possible risk of fraud.
Potential malware. It may be determined that there is a high risk of downloading malware onto the computing device 100 if the browser 200 visits the site.

Examples of rules for determining whether a subcategory of risk exists (e.g., potential man-in-the-middle attack (MITM), phishing, or fraud) are provided below in Table 3. In these examples, it is assumed that the safety level is classified as one of SUSPICIOUS, POOR, NORMAL, and EXCELLENT:

TABLE 3

| | |
|---|---|
| 1. | If the Safety Level classification recently dropped from |
| | EXCELLENT to POOR or worse, there is a potential MITM. |
| 2. | If the Safety Level classification has recently dropped from |
| | EXCELLENT to any other level, and the “Encryption” and |
| | “Certificate Quality” scores have remained constant, there is a |
| | potential MITM. |
| 3. | If the “Certificate Quality” score is TERRIBLE, the |
| | “Reputation” score is POOR, the “Familiarity” score is LOW, |
| | and the “Degree of Inquisitiveness” is HIGH, there is potential |
| | PHISHING. |
| 4. | If “Reputation” score is POOR, the “Familiarity” score is |
| | LOW, but the “Encryption” and “Certificate Quality” scores |
| | are each GOOD or better, there is a potential FRAUD. |

(It should be noted that the Tables 1-3 above are merely intended to provide general examples of the types of classification rules that could be applied in accordance with the present invention, and they are not intended to be limiting as to the format or syntax in which the rules are written or implemented. Furthermore, these classification rules may be stored somewhere in the memory 102 of the computing device 100 (or some other persistent storage) in such manner as to be updated and/or replaced as necessary.)

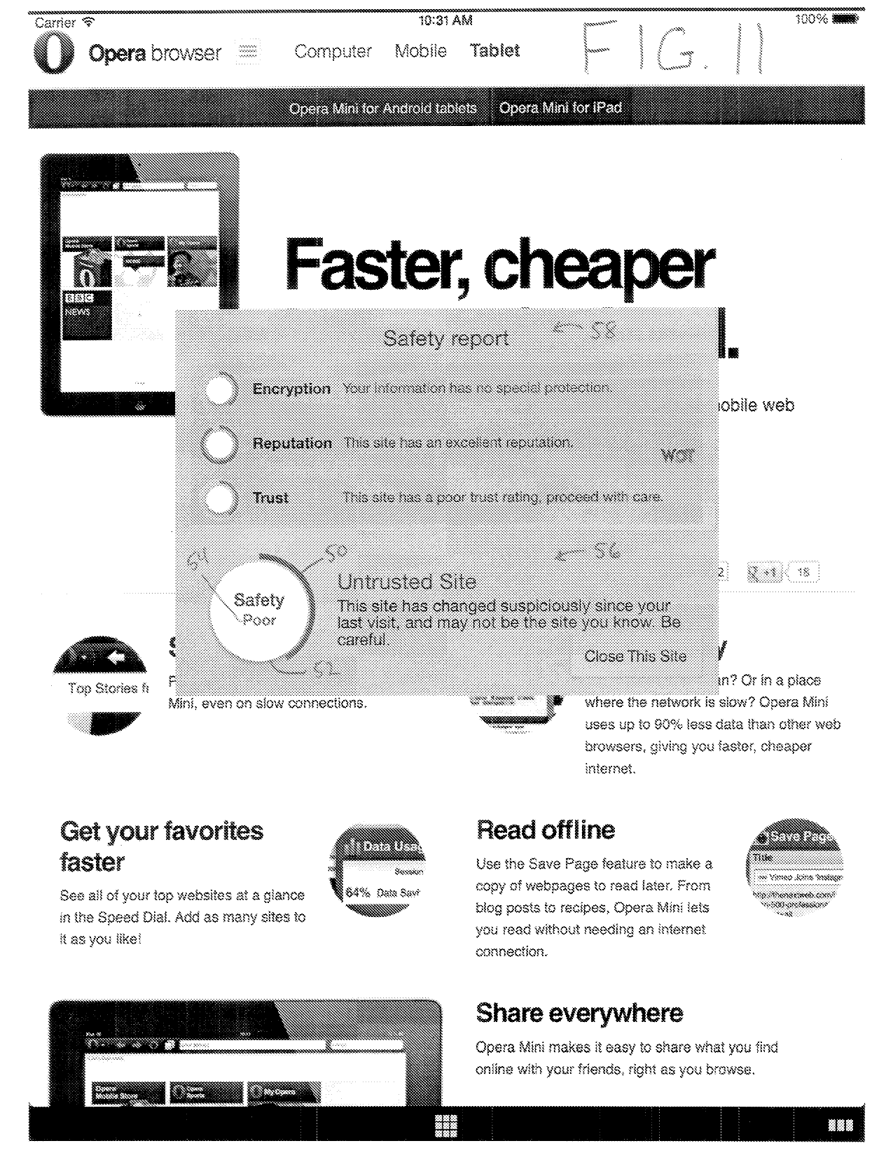

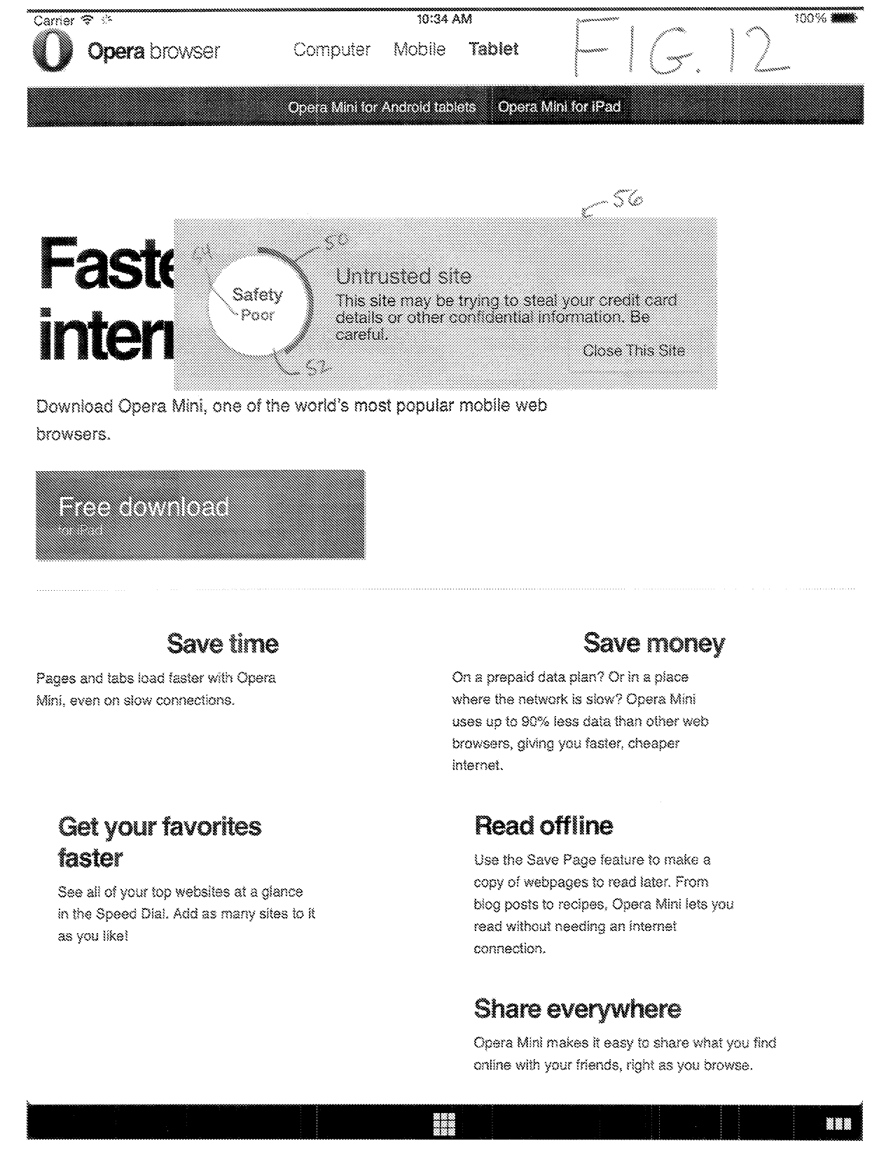

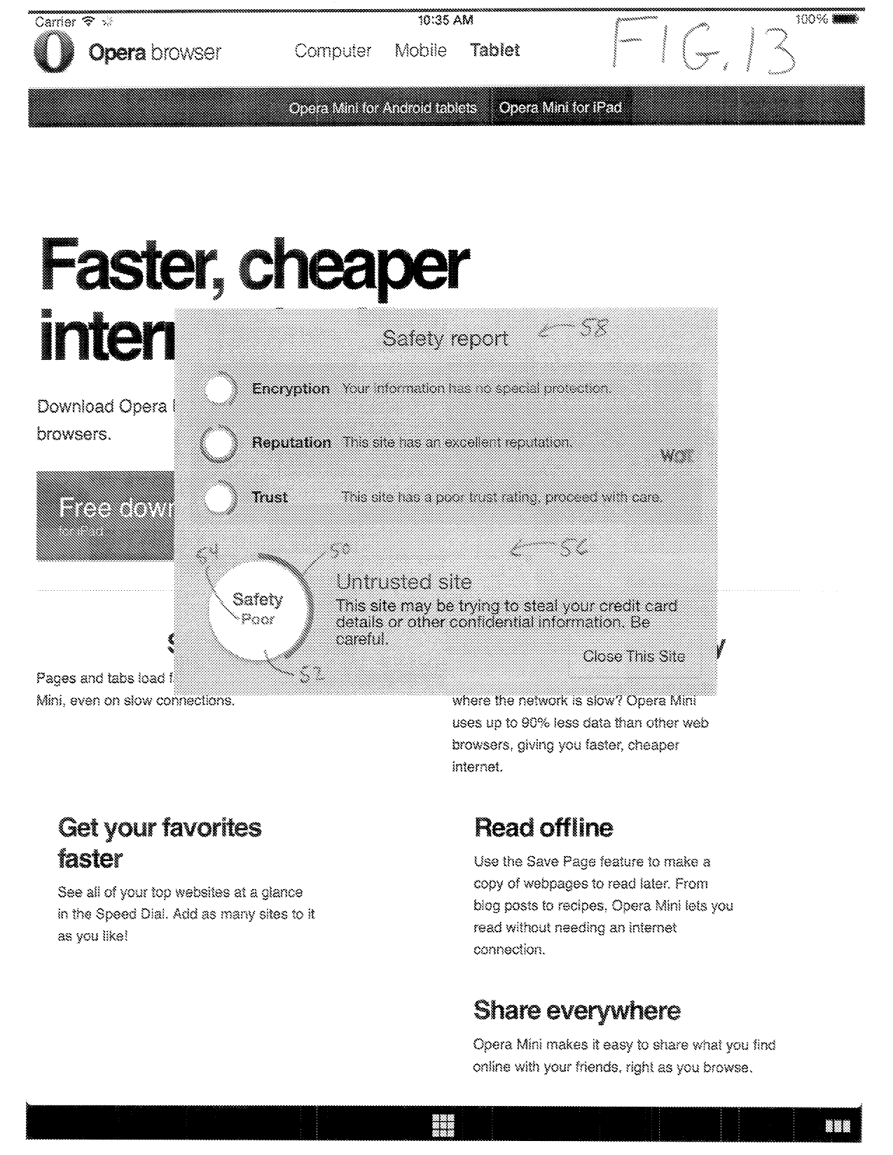

The figures provide various examples of warnings which may be displayed in the indicator 56 on the basis of some of these subcategories. For example, FIGS. 5, 7, 14, and 15 illustrate warnings that are related to potential fraud in indicator 56. Further, FIGS. 10 and 11 illustrate warnings related to a potential MITM. Also, FIGS. 12 and 13 show warnings related to potential phishing in indicator 56.

Referring again to FIG. 3A, this figure illustrates that the process 30 terminates after the user decides either to heed the precautionary measure, or overrides the measure and browses the site (operation S350). However, according to an alternative exemplary embodiment, the security advisor may continue to monitor the safety level of the website. Particularly, the observers may be configured to continuously observe or monitor data while the user is browsing the site, and notify the transitory knowledge base when data is obtained. If this data is not currently reflected in the knowledge base, this could trigger a new evaluation by one or more of the quantifiers, as well as a new classification of the safety level by the risk assessor. The user may then be notified if the safety level changes. This alternative embodiment is illustrated in FIG. 3B.

Particularly, FIG. 3B shows a modified process 30′ that is implemented by the security advisor. It should be noted that process 30′ of FIG. 3B contains various operations that are similarly implemented in the process 30 of FIG. 3A, and thus are labeled with the same reference numbers. There is no need to describe these operations again in connection with FIG. 3B. However, in FIG. 3B, if the user is allowed to browse the active webpage according to operation S350, the various observers continue to monitor regarding the state of the webpage, the browser, the network, user inputs, etc., according to operation S360. When any observer collects some new data, this data is sent to the transitory knowledge base where a decision is made in S370 as to whether this data adds to the body of knowledge of the active webpage, i.e., whether it indicates a change of state (or a noteworthy change of state) in the webpage or the browsing conditions. If S370 decides that the new data represents a change in state, then processing returns to S310 where the categories are reevaluated based on the updated body of knowledge (including the new data, as well as the previously gathered data which has not changed).

Now, a more detailed description will be made as to the operation of the observers and the quantifiers, and the possible types of data and categories which are evaluated in order to classify the safety level of an active webpage. As part of this description, reference will be made to FIG. 4 which illustrates an exemplary process 310 which may be implemented according to operation S310 of FIGS. 3A and 3B. It should be noted that FIG. 4 is merely illustrative. Various operations shown in FIG. 4 may be omitted, while other operations may be combined. For instance, not all of the categories represented in FIG. 4 need be evaluated and scored. Further, it is possible that multiple categories represented in this figure may be evaluated in combination to produce a single score. Also, it is possible to evaluate other categories, which are not shown in FIG. 4, as part of this process 310.

As shown in FIG. 4, the process 310 includes an operation S3110 whereby a transitory knowledge base obtains various data representative of the active webpage as well as the current state of browsing environment, the network state, and other parameters deemed relevant to security and/or trustworthiness of the website. This transitory knowledge base may be stored in a storage device (e.g., somewhere in memory 102). This knowledge base is “transitory” in the sense that it is intended to represent the up-to-date body of knowledge of the active webpage or site in the current browsing context (tab or window). This transitory knowledge base provides the relevant data from which the various categories will be evaluated and scored by the quantifiers, which will be discussed in more detail below.

As described earlier, in an exemplary embodiment, the security advisor contains numerous functional units, referred to as “observer” for monitoring, discover, and relaying respective pieces of information to be assembled into the transitional knowledge base in S3110. FIG. 4 illustrates examples of various types of data that are gathered into the transitory knowledge base. When certain information is collected by one of these observers and forwarded to the knowledge base, operation S3110 may provide a means to consider whether this information is already reflected in the current body of knowledge and, if not, update the transitory knowledge base accordingly.

At least some of the observers may be implemented as, e.g., functional units within the web browser code capable of utilizing Application Programming Interfaces (APIs) in the operating system (OS) of the computing device 100 to obtain certain pieces of information. Particularly, such APIs may be used to intercept network traffic from the website and capture HTTP and Secure Sockets Layer (SSL) information. Such information may include the SSL certificate and headers transmitted by the site.

However, other observers may be programmed to collect information from the browser 200, e.g., by accessing the cache 209, browsing history, user inputs, etc. Other observers may attempt to analyze the webpage content to detect certain patterns. Furthermore, other observers may try to obtain data from third parties.

Furthermore some observers may utilize information obtained by another observer to gather more information. For instance, upon receiving the SSL certificate of the site, an observer may attempt to authenticate the certificate at a centralized certificate authority (CA). Another observer may use the certificate to vet the website at a phishing registry.

In FIG. 4, various observers are pointed out using the reference symbol “OBS.” This figure further attempts to show specific types of information which may be collected by the observers. As shown in FIG. 4, such data may include: details regarding the site's certificate chain, results of attempted site authentication, characteristics of the server hosting the site, whether the site attempts to collect geolocation data from the browser 200, the document input fields, and the site's security policy. However, the data to be collected by the observers need not be limited to information pertaining directly to the site. As shown in FIG. 4, observers may be provided to collect information on: the history of sites visited, details regarding the Wi-Fi or network connection, third-party observations regarding the site's reputation, whether the site is listed on a phishing registry, and whether or not the site (or software employed therein) is listed in a malware registry. Of course, this list of the types of data collected by the observers is not intended to be exhaustive, and other types of observers may be implemented.

However, the category evaluations are not limited to an analysis of data gathered by the observers. It is contemplated that certain categories may also be evaluated using historical data pertaining to the results of previous analyses performed by the security advisor. For example, as shown in FIG. 4, the categories of “Familiarity” and “Trust” may utilize such analyses of historical data, as represented in operations S3112 and S3114. During these historical analyses, S3112 and S3114 may attempt to access historical data, which is stored in a memory or storage device within (or connected to) the computing device 100. This historical data may consist of data relating to previous browsing activities of the user (e.g., how many times the site has been previously visited), as well as data relating to the content of the site during previous visits (e.g., a “fingerprint”). Also, the historical data may include the results of previous analyses by the security advisor, e.g., previous category scores, safety level classifications, and subcategories of risk associated with the website.

Referring again to FIG. 4, operations S3120-S3170 represent various evaluations that can be performed based on the body of knowledge gathered by the observers (as well as historical analyses) to generate scores for respective categories relating to security or trust. In this specification, the term “quantifiers” refers to functional units for performing the evaluations for the respective categories. While FIG. 4 illustrates the evaluations in S3120-S3170 4 as being performed in parallel, this might not always be the case. For instance, one evaluation could be dependent on the results of another (e.g., one quantifier may utilize the score (or some other data) generated by another quantifier to evaluate its own category). It is also possible that certain evaluations may be skipped under certain circumstances. For instance, an evaluation of “Familiarity” may be skipped when the web browser 200 is installed and opened on the device 100 for the first time (and, thus, is not likely to be familiar with any sites).

According to operation S3120, an evaluation is performed on an “Encryption” category. In this evaluation, a quantifier attempts to quantify the strength or effectiveness of the encryption algorithm employed by the website to protect the data (such as HTTP requests) which the browser 200 transmits to the site. Particularly, this evaluation is performed in order to determine how well the website protects such data from eavesdropping by malicious parties. According to an exemplary embodiment, this evaluation may analyze the SSL connection over which each HTTP request (for the main document as well as any embedded resources) is transmitted from the browser 200 to the website. Also, certain contents of the webpage, particularly, the input forms, may be analyzed to deduce the encryption status of any HTTP requests which will be sent when, or if, the form data is submitted. As a result of such analyses, the quantifier can detect the particular type of encryption employed

It should further be noted that, in addition to generating a numeric (or other type of) score, the Encryption quantifier may also be configured to generate a textual description of the encryption status of the site. Further, such a textual description could be displayed to the user along with a visual indication representing the score of the Encryption category (e.g., a bar extending around the perimeter of a circle, the extent of which is representative of the score). For instance, as shown in FIGS. 5, 11, 13, and 15, the web browser 200 may be programmed to display a dialog box which is divided in the following sections:
an indicator 56 in which the classified safety level is displayed (along with any displayed warnings), and
a “Safety Report” section 58 which displays the textual description of the Encryption category (among others), along with the visual indicator of the Encryption score.
   The purpose of such a Safety Report section 58 is to provide curious users with more detailed information regarding the security or trustworthiness of the website. It is possible to configure the security advisor so that the Safety Report pops up in the dialog box in response to a user action, e.g., clicking a particular element in the indicator 56. Alternatively, it would be possible to automatically display this Safety Report, e.g., when certain criteria are met.

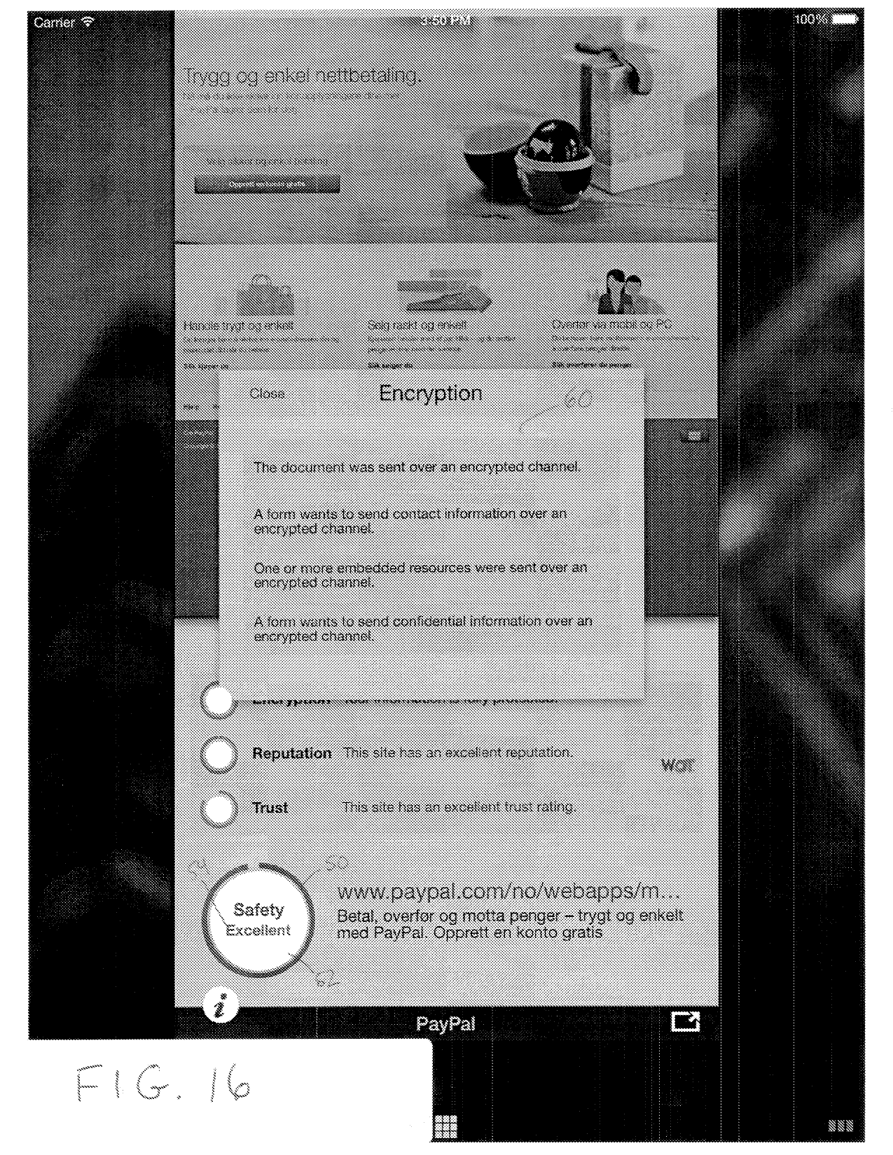

Furthermore, if the user would like even more details into the encryption status of the site, it would be possible to provide additional textual descriptions, e.g., in a new dialog box. An example of this is shown in FIG. 16. This dialog box may pop up, e.g., in response to a user command or input.

Referring again to FIG. 4, according to operation S3130, an evaluation is performed in regard to a category corresponding to a “Degree of Inquisitiveness” of a website. Particularly, this evaluation is intended to generate a score indicating how nosy the website is, i.e., how much the site tries to pry into the affairs of particular browser 200 and/or user. The factors used for scoring this category may include:
how much data does the website seek to extract from the browser/user, and
how personal or private is the data which is sought by the website.
   The more data which the website seeks, and the more personal or private such data is, the higher the score (i.e., degree of inquisitiveness) will be. As described above, a particularly nosy website could possibly be indicative of a malicious intent for the user's personal data, e.g., phishing or MITM.

According to S3140, a “Familiarity” category is evaluated. As mentioned earlier, this evaluation may look at the following factors:
how many times a website has been visited before,
whether the site looks the same (or similar) as before,
whether the site carries the same fingerprint as it did during a previous visit,
whether the site is hosted by the same server as before,
whether the site has been bookmarked in the browser 200, and
whether the site is linked to the user's home screen.
   Several of the aforementioned factors analyze information obtained as a result of one or more previous visits to the website, and thus involve a historical analysis. Further discussion of these factors is provided below.

The more times that a website has been visited by the user, the more likely it is that the user is familiar with the site, thereby positively affecting the Familiarity score so that it indicates a lower degree of risk). On the other hand, factors which are indicative of a change in the website will negatively affect the Familiarity score. I.e., if the site does not look similar as before, and/or does not carry the same fingerprint as a previous visit, this will affect the score so as to indicate an increased degree of risk.

For purposes of this specification, a “fingerprint” refers to a particular set of data (e.g., header data) that is transmitted by the website, which is not expected to change (or change much) unless some characteristic in the website has changed (e.g., the site is utilizing different software, the site is hosted on a different server). According to an exemplary embodiment, operation S3140 generates a fingerprint by extracting and storing a certain set of header data from the site each visit, which is indicative of the type of software being run. If this stored data does not match the header data extracted during the next visit, this indicates that the website is not running the same software as before, thereby negatively affecting the Familiarity score. A similar fingerprinting technique based on header data can be used determine whether the website is hosted on the same server as before. If the server has changed, this will also negatively affect the score so as to indicate a higher degree of risk.

Referring again to FIG. 4, operation S3150 refers to an evaluation of the “Reputation” category. In S3150, the corresponding quantifier evaluates a degree of trustworthiness of the website as indicated by third-party opinion. As such, this evaluation focuses on data from a third party. One way to obtain this information is to transmit data identifying the website (e.g., data of the website's certificate (as obtained in S3110) to a website reputation site, i.e., a third party website which provides a centralized rating system whereby users can rate a particular website or Internet domain in regard to security or trust. Also, in S3150, the browser 200 may poll a malware registry to determine if the website is listed. Thus, it is possible for the quantifier to weigh the information of multiple sources in order to score the Reputation of a website.

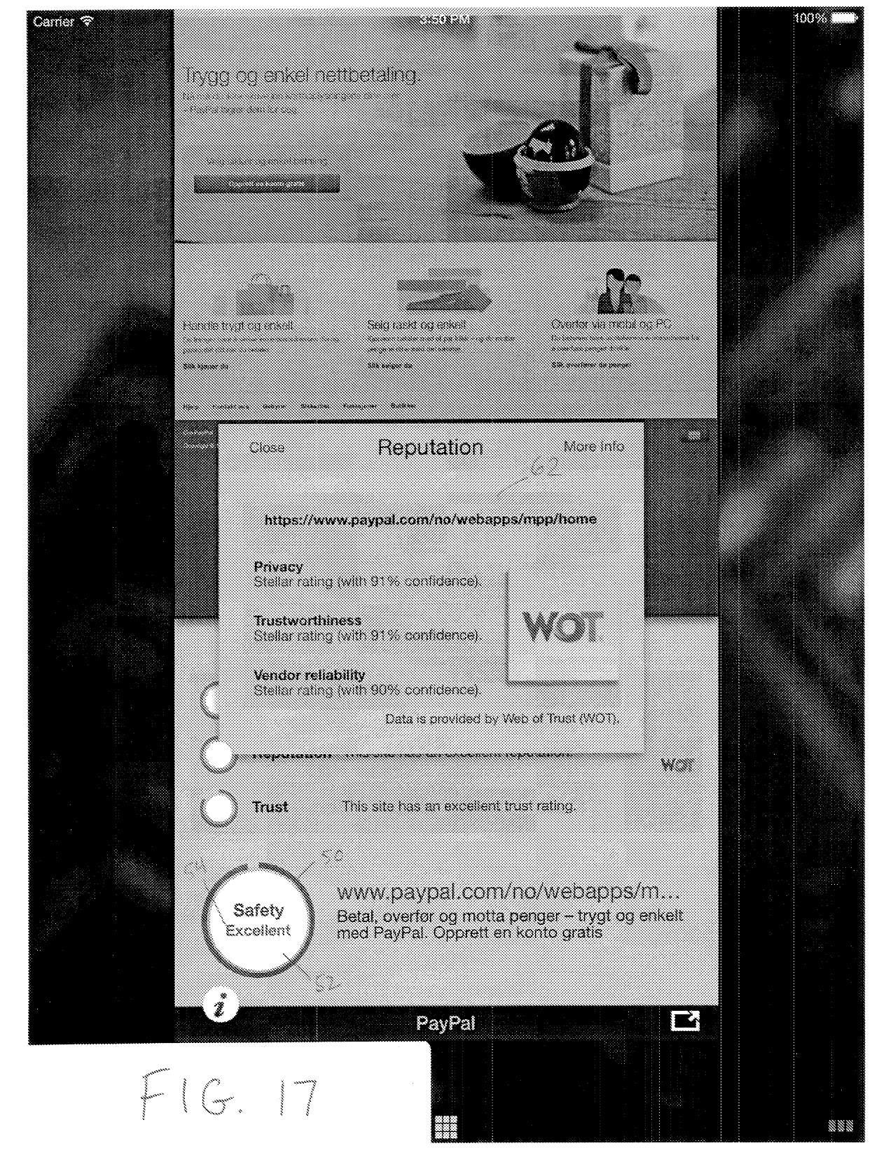

Also, similar to Encryption, the quantifier for the Reputation category could also be configured to generate a textual description regarding the website's reputation. Also, this textual description may be displayed in the Safety Report section 58 of the dialog box, along with a visual indication of the Reputation score (e.g., a bar extending around a perimeter of a circle, the extent of which is representative of the score). Examples of this are illustrated in FIGS. 5, 11, 13, and 15. If the user would like even more information as to why the site received the Reputation score that it did, it would be possible to provide an additional explanation, e.g., in a new dialog box. An example of this is shown in FIG. 17. This may occur, e.g., in response to a user command or input.

In operation S3160 of FIG. 4, an evaluation is performed in regard to a “Certificate Quality” category. Particularly, this category is scored based on the quality of the SSL certificate employed by the website or, in other words, the degree to which the site's certificate is expected to provide secure communications between the browser 200 and the website. The factors to be considered in the Certificate Quality evaluation may include one or more of the following:
whether the website is identified by an SSL certificate,
whether such a certificate was issued by a trusted Certificate Authority (CA),
whether the certificate issuer has revoked the certificate,
whether the website's public key and/or signature algorithm is considered secure, and
the class of the website's certificate (including whether or not the certificate is an Extended Validation (EV)-class certificate)
   Each of these factors could be weighted. An example of how these factors could be used in scoring the Certificate Quality category is given below.

It will be assumed for purposes of this example that the Certificate Quality score is scored on a scale of 0 to 10. If the site does contain an SSL certificate, the score is initially set to a value of 5, and then modified according to the remaining factors. For instance, the quantifier may deduct 5 points from the score if the certificate is deemed to be untrusted. Further, the quantifier may deduct 4 points from the score for an insecure signature algorithm and an insecure key. On the other hand, 1 point could be added to the score if the key is solid. Moreover, 5 points may be added if the quantifier determines that the size of the public key meets a certain threshold. Also, if the quantifier can successfully verify that the SSL certificate has not been revoked, then 2 points may be added to the score. Furthermore, if the certificate fully satisfies the requirements for an Extended Validation (EV) certificate, then 4 points can be added to the score (EV certificates are a class of SSL certificates, which are issued by a Certificate Authority to an entity who satisfies a very extensive set of identity verification criteria).

Further, in this example, it is also possible to convert the Certificate Quality score (as well as the other category scores) to make the application of the rules (in S320) simpler. For instance, the final score could be mapped to one of the following labels: TERRIBLE (score=0, 1, or 2); POOR (score=3, 4, or 5); GOOD (score=6, 7, or 8); and EXCELLENT (score=9 or 10). This could simplify the rules and make them easier to understand (e.g., If the Certificate-Based Security score is EXCELLENT, then . . . ).

It should be noted that the other categories evaluated in process 310 could be scored in a similar manner as described above in the above example regarding Certificate-Based Security.

Referring once again to FIG. 4, in operation S3170, a quantifier may be configured to evaluate a perceived “Trust” category which covers any types of indicia and observations which do not fall neatly in any of the other categories. For instance, in this evaluation, the factors considered may include:
presence of a HTTP Strict Transport Security (HSTS),
if the website has declared a HSTS, whether the network connection satisfies the declared HSTS requirements,
whether there has been a sudden regression or drop-off in the classified safety level since the previous visit,
how stable (or similar) the safety level classifications (and possibly other category scores) have been for this site for previous visits within a given period, and
the evaluated scores of other categories (and, possibly, historical data of the evaluated scores of other categories).

Some of the aforementioned factors can be analyzed using historical information of previous safety level classifications. As mentioned above in regard to FIG. 3A, each time the security advisor produces a classified safety level for a particular website, the results may be stored in persistent storage (see operation S325 of FIG. 3A), and then analyzed according to a historical analysis (see operation S3114 of FIG. 4). However, the Trust category may also be evaluated based on a historical analysis of evaluation scores of other categories. E.g., if the site has achieved a good or excellent Reputation score for an extended period, this could also be indicative that the site deserves a higher level of Trust.

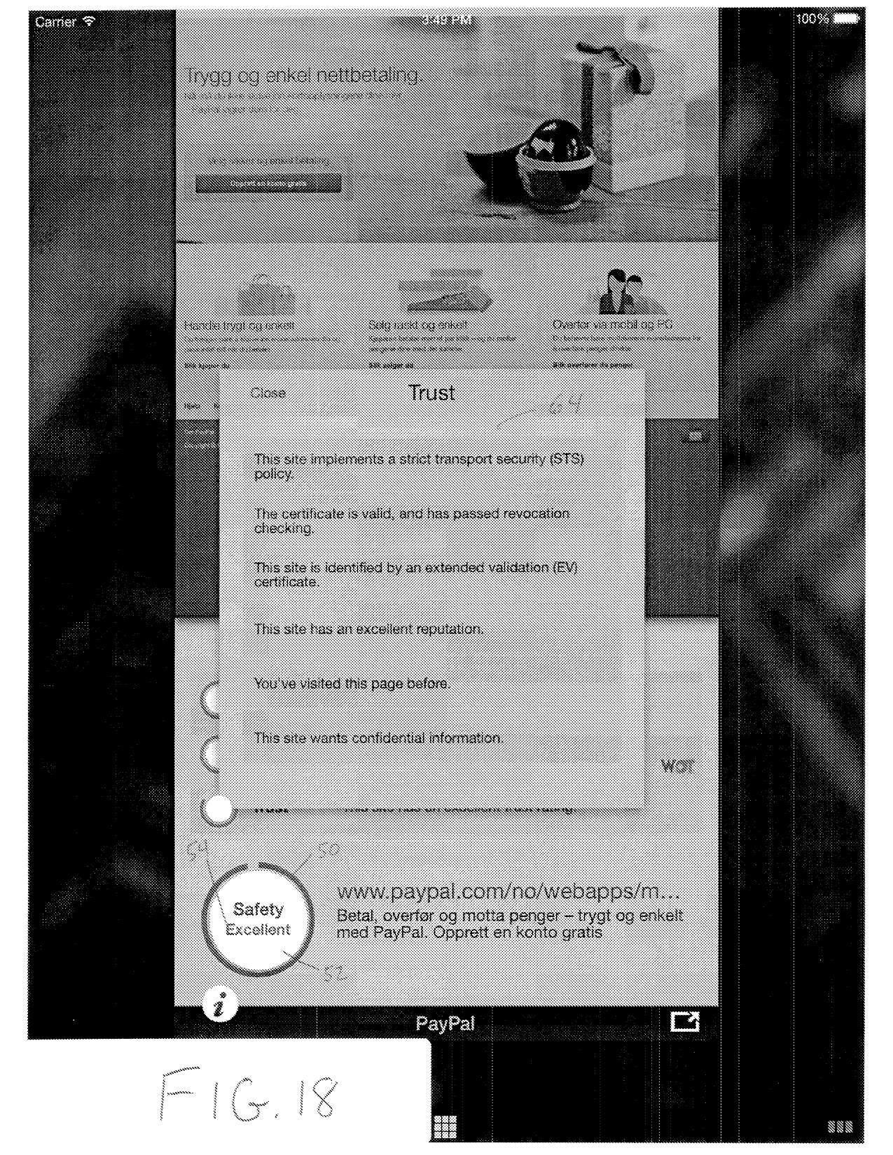

Further, as shown in FIGS. 5, 11, 13, and 15, the quantifier for this Trust category could be configured to generate a textual description with regard to the trustworthiness of the website. This textual description may be displayed in the Safety Report section 58 of the dialog box, along with a visual indication of the Trust score (e.g., a bar extending around the perimeter of a circle, the extent of which is representative of the score). Also, if the user is curious as to why the site achieved the Trust score that it did, a further description may be provided e.g., in a new dialog box. An example of this is shown in FIG. 18.

While particular embodiments are described above for purposes of example, the present invention covers any and all obvious variations as would be readily contemplated by those skilled in the art.

1. A method comprising:
executing, by a computer processor which is currently running a web browser, the following process:
receiving an identifier of a data resource on a network from a user,
classifying a safety level associated with the data resource by:
performing evaluations of the data resource on each of a plurality of categories relating to security or trust,
quantifying the evaluations to associate a score with each of the plurality of categories, and
applying a set of rules to the obtained scores to classify the safety level from among a plurality of classifications;
determining whether a precautionary measure is warranted based on the classified level of risk; and
when a precautionary measure is determined to be warranted, displaying the classified safety level.

2. The method according to claim 1, wherein at least one of the plurality of categories corresponds to encryption employed by the data resource.

3. The method according to claim 2, wherein the category of strength of encryption is quantified according to a degree of strength or effectiveness of the encryption employed by the data resource in protecting data transmitted to and received from the data resource by the web browser from unauthorized access

4. The method according to claim 1, wherein at least one of the plurality of categories corresponds to a degree of inquisitiveness of the data resource.

5. The method according to claim 4, wherein the degree of inquisitiveness is quantified according to at least one of:
how much data the data resource attempts to extract from the web browser, and
how personal is the data which the data resource attempts to extract from the web browser.

6. The method according to claim 1, wherein at least one of the plurality of categories corresponds to familiarity of the data resource, which is quantified according to at least one of:
how many times the data resource has been previously accessed by the web browser,
whether the data resource employs a same software as a previous visit,
whether the data resource is hosted on a same server as a previous visit, and
similarity of a current fingerprint of the data resource with a fingerprint observed by the web browser when previously accessed.

7. The method according to claim 6, further comprising:
storing in a memory at least one of the classified safety level and scores of the plurality of categories as historical data for future evaluation in connection with the familiarity category.

8. The method according to claim 1, wherein at least one of the plurality of categories corresponds to reputation, which is quantified according to a degree of trustworthiness of the data resource as indicated by third-party opinion.

9. The method according to claim 8, wherein the process includes referring to a website where third parties rate various websites or Internet domains for trustworthiness, when evaluating the reputation category.

10. The method according to claim 1, wherein at least one of the plurality of categories corresponds to certificate quality, which is quantified according to the degree to which a Secure Sockets Layer (SSL) certificate of the data resource is expected to provide secure communications between the web browser and the data resource.

11. The method according to claim 10, wherein the certificate quality category is quantified based on at least one of:
whether the data resource is identified by a Secure Sockets Layer (SSL) certificate, and
if the data resource is identified by a SSL certificate,
whether the SSL certificate can be validated by a trusted Certificate Authenticator,
the quality of a signature authentication utilized by the data resource,
the quality of a public key utilized by the data resource,
the size of the public key utilized by the data resource, and
whether the SSL certificate is an Extended Validation (EV) certificate.

12. The method according to claim 1, wherein the plurality of categories includes perceived trustworthiness of the data resource, which is evaluated according to at least one of:
whether data resource has declared an HTTP Strict Transport Security (HSTS) policy set by the data resource,
if the data resource has declared an HSTS policy, whether network conditions match the HSTS policy,
the similarity of classified safety levels for previous visits during a given period, and
whether the classified safety level has decreased between visits.

13. The method according to claim 1, wherein the network is the Internet, the data resource is a website, and the identifier is a universal resource identifier (URL) associated with the website.

14. The method according to claim 1, wherein the classified safety level is selected from a plurality of classifications indicative of degrees of risk, a subset of which is indicative of high risk.

15. The method according to claim 14, further comprising:
when the classified safety level is one of the subset of classifications indicative of high risk, determining a subcategory of type of risk based on application of the set of rules, the subcategory being indicative of at least one of:
potential man-in-the-middle attack;
potential phishing;
potential fraud; and
potential malware.

16. The method according to claim 14, further comprising:
the precautionary measure is determined to be warranted when the classified safety level is one of the subset of classifications indicative of high risk.

17. The method according to claim 14, wherein a precautionary measure is determined to be warranted when the classified safety level is one of the subset of classifications indicative of high risk

18. The method according to claim 14, further comprising:
determining whether to implement another precautionary measure in addition to displaying the classified safety level, the other precautionary measure being selected from one of: warning the user against accessing the data resource, and blocking the web browser from accessing the data resource.

19. The method according to claim 18, further comprising:
when implementing the precautionary measure of blocking the web browser from accessing the data resource, further providing a mechanism whereby the user can override the precautionary measure.

20. A non-transitory computer-readable medium on which is stored coded instructions that, when executed by a computer processor during the course of running a web browser, performs a process of:
receiving an identifier of a data resource on a network from a user,
classifying a safety level associated with the data resource by:
performing evaluations of the data resource on each of a plurality of categories relating to security or trust,
quantifying the evaluations to associate a score with each of the plurality of categories, and
applying a set of rules to the obtained scores to classify the safety level from among a plurality of classifications;
determining whether a precautionary measure is warranted based on the classified level of risk; and
when a precautionary measure is determined to be warranted, displaying the classified safety level.

21. An apparatus comprising a computer processor which, during the course of running a web browser, performs a process of:
receiving an identifier of a data resource on a network from a user,
classifying a safety level associated with the data resource by:
performing evaluations of the data resource on each of a plurality of categories relating to security or trust,
quantifying the evaluations to associate a score with each of the plurality of categories, and
applying a set of rules to the obtained scores to classify the safety level from among a plurality of classifications;
determining whether a precautionary measure is warranted based on the classified level of risk; and
when a precautionary measure is determined to be warranted, displaying the classified safety level.
